(19) United States
(12) Patent Application Publication
(10) Pub. No.: US 2020/0057993 A1
(43) Pub. Date: Feb. 20, 2020

(54) ORDER SCHEDULING METHOD AND APPARATUS, ELECTRONIC DEVICE, AND COMPUTER READABLE STORAGE MEDIUM

(71) Applicant: BEIJING XIAODU INFORMATION TECHNOLOGY CO., LTD., Beijing (CN)

(72) Inventors: Qiuyuan YANG, BEIJING (CN); Mingquan XU, BEIJING (CN); Shaojian HUANG, BEIJING (CN); Ke XIAN, BEIJING (CN); Jinqing CHEN, BEIJING (CN); Jiajia RAO, BEIJING (CN); Dairui CUI, BEIJING (CN)

(21) Appl. No.: 16/663,312

(22) Filed: Oct. 24, 2019

Related U.S. Application Data
(63) Continuation of application No. PCT/CN2017/110293, filed on Nov. 9, 2017.

(30) Foreign Application Priority Data
Apr. 26, 2017 (CN) 201710283581.8

(51) Int. Cl. G06Q 10/08

(52) U.S. Cl. CPC G06Q 10/08355; G06N 5/04; G06Q 10/0838

(57) ABSTRACT

An order scheduling method and apparatus, an electronic device, and a computer-readable storage medium are provided. The method includes: determining delivery capacity pressure corresponding to a delivery area within a current scheduling period; predicting, based on historical data, a delivery capacity pressure change trend variable corresponding to the current scheduling period; adjusting the delivery capacity pressure based on the delivery capacity pressure change trend variable; and scheduling, based on the adjusted delivery capacity pressure, a plurality of orders corresponding to the delivery area within the current scheduling period. Since orders within the current scheduling period are scheduled by taking the future delivery capacity pressure change into consideration, the scheduling on a plurality of orders within the current scheduling period can better adapt to a delivery capacity pressure change, which improves the delivery efficiency.

### CROSS-REFERENCE TO RELATED APPLICATION

This application is a continuation application of International Patent Application No. PCT/CN2017/110293, filed on Nov. 9, 2017, which is based on and claims priority to the Chinese Patent Application No. 201710283581.8, filed on Apr. 26, 2017 and entitled “ORDER SCHEDULING METHOD AND APPARATUS, ELECTRONIC DEVICE, AND COMPUTER READABLE STORAGE MEDIUM.” The above-referenced applications are incorporated herein by reference in their entirety.

### TECHNICAL FIELD

This disclosure relates generally to the field of Internet technologies, and more specifically, to an order scheduling method and apparatus, an electronic device, and a computer-readable storage medium.

### BACKGROUND

With the development of the Internet, Online To Offline (O2O) service, as a novel service mode, has significantly changed people's lifestyles. For example, in terms of shopping, users can order items they need with online shopping applications without leaving home. However, while being convenient to users, these applications must deal with the issue of efficiently scheduling delivery for orders. As a result, various logistics scheduling systems have been developed, whose main object is to assign orders to proper delivery persons so that orders can be delivered to users quickly and efficiently.

Conventionally, upon receiving an order, a logistics scheduling system may assign the order to a specific delivery person based on a specific scheduling policy for the delivery person to complete delivery for the order. The scheduling policy, for example, may include: categorizing, according to the proximity of entry time, a plurality of orders entering the logistics scheduling system into order groups, assigning the order groups to appropriate delivery persons based on a particular assignment rule.

### SUMMARY

Existing logistics scheduling systems may periodically schedule orders at a specific time interval. For example, for every 10 minutes, a logistic scheduling system may schedule orders received within this 10 minutes. Moreover, when orders are scheduled, a plurality of orders in the same delivery area may usually be scheduled together. Furthermore, to maximize delivery capacity, the plurality of orders in a delivery area may be scheduled together based on delivery capacity pressure in the delivery area within a current scheduling period.

For example, in an order grouping process, an order similarity threshold and an order quantity upper limit may be determined based on current delivery capacity pressure. When grouping orders, two orders whose similarity reaching the similarity threshold may be combined into a group until an order quantity in the group reaches the order quantity upper limit.

In the foregoing method, the delivery capacity pressure within the current scheduling period may be taken into consideration for order scheduling, thus the delivery efficiency may be improved. However, in practical applications, order scheduling may face the following problems.

Based on the delivery capacity pressure, it may be necessary to set a relatively low similarity threshold and a relatively high order quantity upper limit corresponding to a specific scheduling period T1. However, in practice, it is possible that the quantity of orders received by the logistics scheduling system in one or more scheduling periods following the scheduling period T1 may be greatly reduced, which may correspondingly reduce the delivery capacity pressure therein. In that case, for the current scheduling period T1, it is not necessary to set a very low similarity threshold or a very high order quantity upper limit. That is, an order group does not necessarily include a large quantity of orders, which leads to heavy workload for delivery persons to which the orders are assigned. Nor is it necessarily to set a very small quantity of order groups, which lowers the delivery efficiency for orders. For that case, in practice, the similarity threshold can be appropriately increased and the order quantity upper limit can be appropriately lowered to generate more order groups each including a small number of orders. Thus more delivery persons can be involved to complete delivery of the orders within the scheduling period T1, and the orders delivery can be completed more quickly, thereby improving the delivery efficiency.

As described above, for a certain delivery area, scheduling orders within a current scheduling period by only considering delivery capacity pressure corresponding to the current scheduling period may not lead to an optimal overall efficiency.

In view of the foregoing limitations, this disclosure provides an order scheduling method and apparatus, an electronic device, and a computer-readable storage medium. In this disclosure, orders within a current scheduling period are scheduled by considering a delivery capacity pressure change trend to improve the delivery efficiency.

One aspect of the present invention is directed to an order scheduling method. The method my include: determining delivery capacity pressure corresponding to a delivery area within a current scheduling period, wherein the delivery capacity pressure may be a ratio of a quantity of uncompleted orders to a quantity of delivery persons corresponding to the delivery area within the current scheduling period; predicting, based on historical data, a delivery capacity pressure change trend corresponding to the current scheduling period; adjusting the delivery capacity pressure based on the delivery capacity pressure change trend; and scheduling, based on a grouping parameter and/or an order combination parameter determined by the adjusted delivery capacity pressure, a plurality of orders corresponding to the delivery area within the current scheduling period.

In some embodiments, adjusting the delivery capacity pressure based on the delivery capacity pressure change trend may include: in response to a determination, based on the delivery capacity pressure change trend, that a change amplitude of a delivery capacity pressure is less than a preset threshold, maintaining the delivery capacity pressure unchanged; in response to a determination, based on the delivery capacity pressure change trend, that the delivery capacity pressure rises more than the preset threshold, increasing the delivery capacity pressure according to a first preset adjustment coefficient; and in response to a determination, based on the delivery capacity pressure change trend, that the delivery capacity pressure drops more than the preset threshold, decreasing the delivery capacity pressure according to a second preset adjustment coefficient.

In some embodiments, scheduling, based on the adjusted delivery capacity pressure, a plurality of orders corresponding to the delivery area within the current scheduling period may include at least one of the following two operations: (1). determining the grouping parameter based on the adjusted delivery capacity pressure, and grouping the plurality of orders based on the grouping parameter; and (2). determining the order combination parameter based on the adjusted delivery capacity pressure, and combining the plurality of orders for a delivery person based on the order combination parameter.

In some embodiments, determining delivery capacity pressure corresponding to a delivery area within a current scheduling period may include: obtaining the quantity of uncompleted orders and the quantity of delivery persons corresponding to the delivery area within the current scheduling period; and determining the delivery capacity pressure based on the quantity of uncompleted orders and the quantity of delivery persons.

In some embodiments, the aforementioned method may further include: determining historical average delivery capacity pressure corresponding to the delivery area within each of a plurality of scheduling periods; and determining, based on historical average delivery capacity pressure corresponding to at least one scheduling period after a selected scheduling period from the plurality of scheduling periods, a delivery capacity pressure change trend corresponding to the selected scheduling period.

The historical average delivery capacity pressure may correspond to an average value of delivery capacity pressure in a plurality of days.

In some embodiments, the aforementioned method may further include: after determining historical average delivery capacity pressure corresponding to the delivery area within each of a plurality of scheduling periods, smoothing the historical average delivery capacity pressure corresponding to each of the plurality of scheduling periods.

Another aspect of the present invention is directed to an order scheduling apparatus. The apparatus may include: a first determination module, an obtaining module, an adjustment module, and a scheduling module. The first determination module may be configured to determine delivery capacity pressure corresponding to a delivery area within a current scheduling period. The delivery capacity pressure may be a ratio of a quantity of uncompleted orders to a quantity of delivery persons corresponding to the delivery area within the current scheduling period. The obtaining module may be configured to predict, based on historical data, a delivery capacity pressure change trend variable corresponding to the current scheduling period. The adjustment module may be configured to adjust the delivery capacity pressure based on the delivery capacity pressure change trend variable. The scheduling module may be configured to schedule, based on a grouping parameter and/or an order combination parameter determined by the adjusted delivery capacity pressure, a plurality of orders corresponding to the delivery area within the current scheduling period.

In some embodiments, the structure of the forgoing order scheduling apparatus may include a processor and a memory. The memory may be configured to store a program executable by the processor. Upon being executed by the processor, the program may cause the processor to perform the order scheduling method in any of the aforementioned embodiments. The order scheduling apparatus may also include a communication interface for the order scheduling apparatus to communicate with other devices or communications networks.

Another aspect of the present invention is directed to a computer-readable storage medium storing, for an order scheduling apparatus, computer software instructions executable by a processor. Upon being executed by the processor, the computer software instructions may cause processor to perform the order scheduling method in any of the aforementioned embodiments.

According to the order scheduling method and apparatus provided in the embodiments of this disclosure, for any delivery area, when a plurality of orders received within a current scheduling period need to be scheduled, delivery capacity pressure corresponding to the delivery area within the current scheduling period may first be determined. Then a delivery capacity pressure change trend corresponding to the current scheduling period may be determined based on historical data, based on which the delivery capacity pressure corresponding to the current scheduling period may be adjusted. That is, in this invention, the delivery capacity pressure within the current scheduling period may be adjusted based on a future delivery capacity pressure change. Finally, a plurality of orders received within the current scheduling period may be scheduled based on the adjusted delivery capacity pressure. Since the orders within the current scheduling period are scheduled taking into consideration the future delivery capacity pressure change, the plurality of orders within the current scheduling period may be scheduled adaptively according to the delivery capacity pressure change trend. Thus the scheduling efficiency may be improved.

### BRIEF DESCRIPTION OF THE DRAWINGS

To describe the technical solutions in embodiments of this disclosure or in the prior art more clearly, the following outlines accompanying drawings to be used in the description of the embodiments of this disclosure. Apparently, the accompanying drawings outlined below are merely some embodiments of this disclosure, and a person of ordinary skill in the art may derive other drawings from these accompanying drawings without creative efforts.

FIG. 1 is a flowchart illustrating an order scheduling method in accordance with a first embodiment of this disclosure.

FIG. 2 is a flowchart illustrating an order scheduling method in accordance with a second embodiment of this disclosure.

FIG. 3 is a flowchart illustrating one implementation of step 104 in the embodiment shown in FIG. 1.

FIG. 4 is a flowchart illustrating another implementation of step 104 in the embodiment shown in FIG. 1.

FIG. 5 is a schematic structural diagram of an order scheduling apparatus in accordance with a first embodiment of this disclosure.

FIG. 6 is a schematic structural diagram of an order scheduling apparatus in accordance with a second embodiment of this disclosure.

FIG. 7 is a schematic structural diagram of an order scheduling apparatus in accordance with a third embodiment of this disclosure.

FIG. 8 is a schematic structural diagram of an order scheduling apparatus in accordance with a fourth embodiment of this disclosure.

FIG. 9 is a schematic structural diagram of an order scheduling apparatus in accordance with a fifth embodiment of this disclosure.

### DETAIL DESCRIPTION OF THE EMBODIMENTS

To make the objectives, technical solutions, and advantages of embodiments of this disclosure clearer, a clear description of technical solutions in the embodiments of this disclosure will be presented in full below with reference to accompanying drawings. Apparently, the described embodiments are some but not all of the embodiments of this disclosure. All other embodiments derived by a person of ordinary skill in the art based on the embodiments in this disclosure without creative efforts shall fall within the protection scope of this disclosure.

The terms used in the embodiments of this disclosure are intended merely for describing specific embodiments rather than limiting this disclosure. The singular forms “a”, “the”, and “said” used in the embodiments of this disclosure and the claims attached hereto are intended to also include plural forms thereof. Unless otherwise expressly indicated in the context, “a plurality of” generally indicates at least two, but without excluding indication of at least one.

It should be understood that the term “and/or” used in the text merely refers to an association describing associated objects, indicating that there may be three relationships, for example, A and/or B may indicate three cases: only A exists, both A and B exist, and only B exists. In addition, the character “/” used herein generally indicates an “or” relationship between associated objects.

It should be understood that although the terms such as “first”, “second”, and “third” may be used in the embodiments of this disclosure to describe certain objects, the certain objects shall not be limited by these terms. These terms are merely used to distinguish the certain objects from each other. For example, without departing from the scope of the embodiments of this disclosure, a first object may also be referred to as a second object. Similarly, a second object may also be referred to as a first object.

Depending on the context, the words “in case” and “if” used herein may be interpreted to mean “when” or “while” or “in response to determining” or “in response to detecting”. Similarly, depending on the context, the phrase “if it is determined that” or “if it is detected that (a condition or event stated)” may be interpreted as “when it is determined that” or “in response to determining” or “when it is detected that (a condition or event stated)” or “in response to detecting (a condition or event stated)”.

It should also be noted that the terms “including”, “comprising” or any other variations thereof are intended to encompass a non-exclusive inclusion, so that an item or system including a series of elements includes not only those elements but also other elements that are not specifically listed or inherent elements of the item or system. Except as otherwise limited, an element defined by the phrase “including a . . . ” does not exclude existence of additional identical elements in the item or system that includes the element.

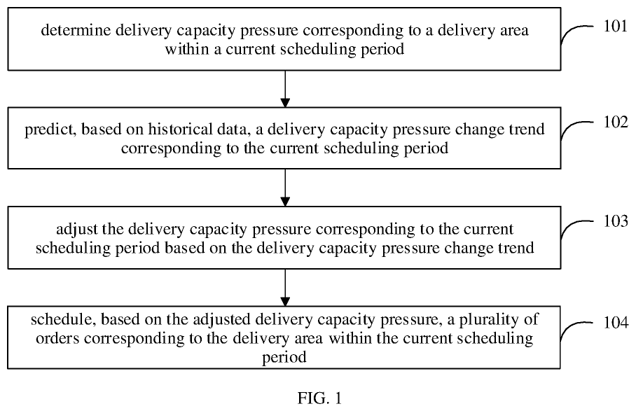

FIG. 1 is a flowchart illustrating an order scheduling method in accordance with a first embodiment of this disclosure. The order scheduling method provided in this embodiment may be executed by an order scheduling apparatus, which may be implemented as software or a combination of software and hardware, and may be integrated in a device for a logistics scheduling platform (e.g., in a server). As shown in FIG. 1, the method may include the following steps 101 to 104.

In step 101, delivery capacity pressure corresponding to a delivery area within a current scheduling period may be determined.

In this embodiment, a takeout delivery scenario is used as an example. It is assumed that a plurality of orders are received within the current scheduling period, and the plurality of orders may correspond to the same delivery area. In some embodiments, the plurality of orders corresponding to the same delivery area may mean that source addresses in the plurality of orders are all in the same delivery area. In some embodiments, the plurality of orders corresponding to the same delivery area may mean that destination addresses in the plurality of orders are all in the same delivery area. In some embodiments, the plurality of orders corresponding to the same delivery area may mean that both source addresses and destination addresses in the plurality of orders are in the same delivery area.

When scheduling the plurality of orders, the delivery capacity pressure corresponding to the delivery area within the current scheduling period (i.e., current delivery capacity pressure) may first be determined, and the plurality of orders may be scheduled based on the delivery capacity pressure.

The delivery capacity pressure can be understood as an average quantity of orders to be delivered by delivery persons in the delivery area within the current scheduling period. The delivery capacity pressure, for example, may simply be expressed as: the quantity of uncompleted orders in the delivery area within the current scheduling period divided by the quantity of delivery persons in the delivery area within the current scheduling period. The quantity of delivery persons may refer to the quantity of on-duty delivery persons or the quantity of online delivery persons.

Therefore, in order to determine the delivery capacity pressure, the quantity of uncompleted orders and the quantity of delivery persons corresponding to the delivery area within the current scheduling period may first need to be obtained. Then the delivery capacity pressure may be determined based on the quantity of uncompleted orders and the quantity of delivery persons.

For any individual order, a delivery person generally may need to first go to a source address to obtain an item to be delivered, and then send the item to a destination address. Therefore, in this embodiment, the quantity of uncompleted orders consists of the quantity of unassigned orders, the quantity of orders in a pickup state, and the quantity of orders in a delivery state. An unassigned order may refer to an order that has not been assigned to any delivery person. An order in the pickup state may refer to an order that has been assigned to a delivery person who has accepted the order and is to pick up the item at the source address. An order in the delivery state may refer to an order for which the delivery person has already picked up the item and is delivering the item to the destination address. In some embodiments, the unassigned state, the pickup state, and the delivery state of an order can be determined based on a report from the delivery person. That is, the delivery person may actively report a current order state whenever the delivery state of an order is changed.

In step 102, based on historical data, a delivery capacity pressure change trend corresponding to the current scheduling period may be predicted.

In some embodiments, to improve the overall delivery efficiency, when the plurality of orders within the current scheduling period are scheduled, in addition to the delivery capacity pressure in the delivery area within the current scheduling period, a future delivery capacity pressure change may also be taken into consideration. The delivery capacity pressure within the current scheduling period may be adjusted based on a future delivery capacity pressure change trend, so that the scheduling on the plurality of orders within the current scheduling period may better match the future delivery capacity pressure change trend.

To adjust the delivery capacity pressure within the current scheduling period based on the future delivery capacity pressure change trend, the future delivery capacity pressure change trend may first be obtained. That is, a delivery capacity pressure change trend corresponding to the current scheduling period may first be obtained.

The delivery capacity pressure change trend within the current scheduling period may be determined based on historical data. Specifically, the current scheduling period may refer to a scheduling period in a current working day, and the corresponding delivery capacity pressure change trend thereof may be determined based on a delivery capacity pressure change trend in a corresponding scheduling period in history. Here, “in history” may refer to in one or more historical working days.

The delivery capacity pressure change trend in a corresponding scheduling period in history can be determined based on a change between a delivery capacity pressure within one or more scheduling periods following the corresponding scheduling period and a delivery capacity pressure within the corresponding scheduling period. For example, if a delivery capacity pressure within the one or more scheduling periods following the corresponding scheduling period rises with respect to a delivery capacity pressure within the corresponding scheduling period, it may be determined that the delivery capacity pressure change trend corresponding to the corresponding scheduling period is a rising trend. Therefore, it may be determined that the delivery capacity pressure change trend corresponding to the current scheduling period is a rising trend.

It should be noted that, in this embodiment of this disclosure, a working day may mean a day having a to-be-delivered order.

The foregoing process of determining the delivery capacity pressure change trend corresponding to the current scheduling period and a correspondence between the current scheduling period and the foregoing corresponding scheduling period are described below through specific examples.

In one example, in a logistics scheduling system, one working day can be divided into several scheduling periods. For example, each scheduling period may be 10 minutes. That is, a working day is divided into scheduling periods from a start time at in interval of 10 minutes. For example, a work start time may be 8:00, and 8:00-8:10 may be the first scheduling period, 8:10-8:20 may be the second scheduling period, and so on.

Assuming that the foregoing current scheduling period is the first scheduling period (i.e., 8:00-8:10) of the current working day (e.g., March 10), and the foregoing certain historical working day in history may be a day that is seven days before the current working day (i.e., March 3). In this case, the first scheduling period on March 3 may be the corresponding scheduling period of the current scheduling period (i.e., the first scheduling period) of the current working day, March 10. Therefore, the delivery capacity pressure change trend corresponding to the current scheduling period can be determined by obtaining the delivery capacity pressure change trend corresponding to the first scheduling period on March 3. The delivery capacity pressure change trend corresponding to the first scheduling period on March 3 can be determined based on delivery capacity pressure change trends of the delivery capacity pressure within the one or more scheduling periods following the first scheduling period with respect to the first scheduling period. When the delivery capacity pressure change trend of the first scheduling period is determined based on delivery capacity pressure change trends of delivery capacity pressure within a plurality of scheduling periods following the first scheduling period with respect to the first scheduling period, the delivery capacity pressure change trend within the first scheduling period can be determined based on a delivery capacity pressure change trend of an average value of the delivery capacity pressure within the plurality of scheduling periods with respect to the first scheduling period.

On this basis, in some embodiments, for the current working day, respective delivery capacity pressure change trends corresponding to a plurality of scheduling periods can be pre-determined based on corresponding delivery capacity pressure in the historical working day within the plurality of scheduling periods. Thus, for the current working day, if the delivery capacity pressure change trend corresponding to a particular current scheduling period needs to be obtained, it can be obtained through direct search.

In addition, in practice, the delivery capacity pressure change trend can be represented by a delivery capacity pressure change trend variable, which can reflect a delivery capacity pressure change direction and a delivery capacity pressure change amplitude. For example, the delivery capacity pressure change trend variable can be expressed as a slope.

In step 103, the delivery capacity pressure corresponding to the current scheduling period may be adjusted based on the delivery capacity pressure change trend.

In this embodiment, if the delivery capacity pressure change trend variable indicates that the delivery capacity pressure change amplitude is relatively small, there is no need to adjust the delivery capacity pressure within the current scheduling period. If the delivery capacity pressure change trend variable indicates that the delivery capacity pressure change amplitude is relatively large, the delivery capacity pressure within the current scheduling period may need to be adjusted, so as to adapt to future delivery capacity pressure.

More specifically, if the delivery capacity pressure change trend indicates that a change amplitude of the delivery capacity pressure is less than a preset threshold (e.g., the delivery capacity pressure change trend variable ranges between a first threshold and a second threshold (the first threshold is less than the second threshold), indicating that the delivery capacity pressure change amplitude is relatively small), the delivery capacity pressure within the current scheduling period may remain unchanged.

If the delivery capacity pressure change trend indicates that a delivery capacity pressure rises more than the preset threshold (e.g., the delivery capacity pressure change trend variable is greater than the second threshold, indicating that the delivery capacity pressure has an obvious rising trend), the delivery capacity pressure within the current scheduling period may be increased according to a first preset adjustment coefficient. The first preset adjustment coefficient may be greater than 1.

If the delivery capacity pressure change trend indicates that a delivery capacity pressure drops more than the preset threshold (e.g., the delivery capacity pressure change trend variable is less than the first threshold, indicating that the delivery capacity pressure has an obvious dropping trend), the delivery capacity pressure within the current scheduling period may be decreased according to a second preset adjustment coefficient. The second preset adjustment coefficient may be a positive number less than 1.

In step 104, based on the adjusted delivery capacity pressure, a plurality of orders corresponding to the delivery area within the current scheduling period may be scheduled.

A scheduling process for the plurality of orders, for example, may include: a process of dividing the plurality of orders into groups and assigning the obtained order groups to appropriate delivery persons; and/or a process of separately combining the plurality of orders for appropriate delivery persons. This is to be described in subsequent embodiments.

In one embodiment, during order scheduling, a magnitude of the delivery capacity pressure may be related to an order scheduling policy. Taking an order grouping process as an example, an order similarity threshold and an order quantity upper limit may be determined based on the current delivery capacity pressure. When grouping orders, if a similarity between two orders reaches the similarity threshold, the two orders may be combined into a group until the order quantity upper limit is reached. If the delivery capacity pressure is increased, the similarity threshold can be lowered and the order quantity upper limit can be increased. That is, if the delivery capacity pressure is relatively low, the corresponding similarity threshold may be relatively high, so that a probability of multiple orders being combined into one group is small, and the quantity of orders in an order group is relatively small. This corresponds to the case where the delivery capacity pressure is small. If the delivery capacity pressure is relatively high, the corresponding similarity threshold may be relatively low, so that a probability of multiple orders being combined into one group is high, and the quantity of orders in an order group is large. This corresponds to the case where the delivery capacity pressure is high. Therefore, in practical applications, in order to flexibly adjust the order scheduling policy to adapt to changing order delivery capacity pressure, the similarity threshold can be lowered when the delivery capacity pressure is relatively high, and be increased when the delivery capacity pressure is relatively small, as described above.

In this embodiment, when a plurality of orders received within a current scheduling period need to be scheduled for a delivery area, delivery capacity pressure corresponding to the delivery area within the current scheduling period may be first determined. Then a delivery capacity pressure change trend of a historical scheduling period corresponding to the current scheduling period may be determined based on historical data. Then, based on the delivery capacity pressure change trend, the delivery capacity pressure corresponding to the current scheduling period may be adjusted. That is, in this solution, the delivery capacity pressure within the current scheduling period may be adjusted based on a future delivery capacity pressure change. Finally, a plurality of orders received within the current scheduling period may be scheduled based on the adjusted delivery capacity pressure. Since the orders within the current scheduling period are scheduled taking into consideration the future delivery capacity pressure change, the scheduling on the plurality of orders within the current scheduling period can better adapt to the delivery capacity pressure change trend. Thus the scheduling efficiency may be improved.

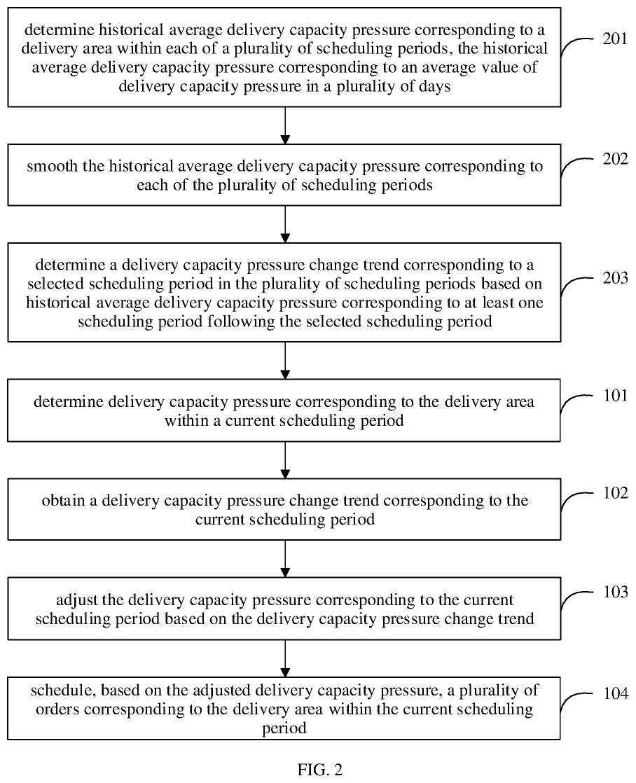

FIG. 2 is a flowchart illustrating an order scheduling method in accordance with a second embodiment of this disclosure. As shown in FIG. 2, before step 101, the method may further include the following steps 201 to 203.

In step 201, historical average delivery capacity pressure corresponding to a delivery area within each of a plurality of scheduling periods may be determined. The historical average delivery capacity pressure may correspond to an average value of delivery capacity pressure in a plurality of days.

In step 202, the historical average delivery capacity pressure corresponding to each of the plurality of scheduling periods may be smoothed.

In step 203, a delivery capacity pressure change trend corresponding to a selected scheduling period in the plurality of scheduling periods may be determined based on historical average delivery capacity pressure corresponding to at least one scheduling period following the selected scheduling period.

In this embodiment, for a particular delivery area, delivery capacity pressure change trends corresponding to the plurality of scheduling periods can be pre-determined by using data in a plurality of historical working days, so that when orders within the plurality of scheduling periods in a current working day are scheduled, a corresponding delivery capacity pressure change trend can be obtained by searching.

Specifically, a working day may be divided into a plurality of scheduling periods in advance. For a delivery area, historical average delivery capacity pressure corresponding to the delivery area within each of the plurality of scheduling periods may first be determined. The historical average delivery capacity pressure may correspond to an average value of delivery capacity pressure in a plurality of days. That is, for any one of the scheduling periods, delivery capacity pressure corresponding to the delivery area within the scheduling period in a plurality of historical working days may be determined. Then an average value of the plurality of determined delivery capacity pressure may further be calculated as historical average delivery capacity pressure corresponding to the scheduling period.

For example, if a working day is divided into 100 scheduling periods, for a particular delivery area, assuming that delivery capacity pressure corresponding to the delivery area in an i^{th} scheduling period (i.e., a selected scheduling period) in the first historical working day is a, delivery capacity pressure corresponding to the delivery area in the i^{th} scheduling period in the second historical working day is b, and delivery capacity pressure corresponding to the delivery area within the i^{th} scheduling period in the third historical working day is c, and only data in the three historical working days is used, the historical average delivery capacity pressure corresponding to the i^{th} scheduling period may be an average value of a, b, and c.

The calculation process of the delivery capacity pressure in the delivery area within the current scheduling period in the embodiment shown in FIG. 1 may be referred to for the calculation process of the delivery capacity pressure corresponding to the i^{th} scheduling period in each historical working day, and details of the calculation process thus are not repeatedly described herein. A value of i may be less than the total quantity of scheduling periods (e.g., 100 in the foregoing example). That is, delivery capacity pressure within the last one or more scheduling periods may not be adjusted.

In addition, M continuous days or M separated days prior to the current working day may be selected as historical working days. For example, if the current working day is Saturday, since a user's order on Saturday and Sunday is obviously different from that on Monday to Friday, the past, for example, 20 Saturdays and Sundays may be selected as the historical working days.

After determining the historical average delivery capacity pressure corresponding to the particular delivery area within each of the plurality of scheduling periods, an average delivery capacity pressure curve can be drawn, where abscissas of the curve may represent the plurality of scheduling periods, and ordinates thereof may represent the historical average delivery capacity pressure.

Next, to ensure that the curve is as smooth as possible so that the delivery capacity pressure change trend over a period of time may be smoothly represented in subsequent processes, and sudden irrational change of the change trend may be avoid, the curve may be smoothed. That is, the respective historical average delivery capacity pressure corresponding to the different scheduling periods may be smoothed.

An optional smoothing method is window filtering. In this method, a window size may first be set at 2K+1 (i.e., if K=2, a window size will be 5). In this case, the i^{th} scheduling period (i.e., the selected scheduling period, denoted as Ni) in the foregoing plurality of scheduling periods, the previous two scheduling periods (N(i−1) and N(i−2)), and the next two scheduling periods (N(i+1) and N(i+2)) can be selected. That is, there are five scheduling periods in total. Therefore, the historical average delivery capacity pressure corresponding to Ni, for example, can be smoothed to be an average value of respective historical average delivery capacity pressure corresponding to the five scheduling periods. The smoothing method and the window size are only exemplary, and other smoothing methods and window size can be used, and this invention is not limited in this regard.

Furthermore, the delivery capacity pressure change trend corresponding to the i^{th} scheduling period in the foregoing plurality of scheduling periods may be determined based on the respective historical average delivery capacity pressure corresponding to at least one scheduling period following the i^{th} scheduling period.

To avoid frequently adjusting current delivery capacity pressure within any scheduling period based only on a change of a delivery capacity pressure change trend within the corresponding scheduling period, the delivery capacity pressure change trend can be represented by a variable that reflects not only a direction, but also an amplitude, of a change of delivery capacity pressure. That is, in this embodiment of this disclosure, a delivery capacity pressure change trend may include both a change direction and a change amplitude.

In some embodiments, a delivery capacity pressure change trend variable may be represented by a slope. In one example, assuming that the i^{th} scheduling period is Ni, and the corresponding delivery capacity pressure change trend variable is calculated for the fifth scheduling period following Ni, the slope may be calculated with a step size of 5. In this case, the delivery capacity pressure change trend variable corresponding to Ni can be represented as: (N(i+5)−Ni)/5, wherein N(i+5) is historical average delivery capacity pressure corresponding to the fifth scheduling period following the i^{th} scheduling period, and Ni is historical average delivery capacity pressure corresponding to the i^{th} scheduling period. A positive result may indicate that the delivery capacity pressure has a rising trend, while a negative result indicating that the delivery capacity pressure has a dropping trend. A value of the result may reflect an amplitude of the change.

Based on the above description, the delivery capacity pressure change trend variables corresponding to the plurality scheduling periods can be obtained, so that a correspondence between the plurality of scheduling periods and the delivery capacity pressure change trend variables in the corresponding delivery area can be saved. Therefore, for the delivery area, when orders are scheduled within the current scheduling period in the current working day, the foregoing correspondence can be referred to obtain the corresponding delivery capacity pressure change trend variable based on the current scheduling period, so that the delivery capacity pressure within the current scheduling period may be adjusted. Further, the plurality of orders received within the current scheduling period may be scheduled based on the adjusted delivery capacity pressure. Since the orders within the current scheduling period are scheduled taking into consideration the future delivery capacity pressure change, the scheduling on the plurality of orders within the current scheduling period can better adapt to the delivery capacity pressure change trend. Thus the scheduling efficiency may be improved.

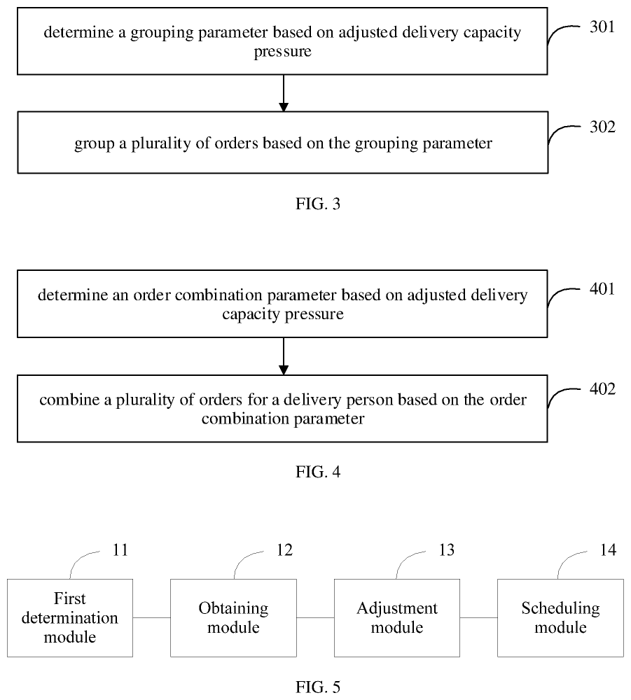

FIG. 3 is a flowchart illustrating one implementation of step 104 in the embodiment shown in FIG. 1. As shown in FIG. 3, step 104 may include the following steps 301 and 302.

In step 301, a grouping parameter may be determined based on adjusted delivery capacity pressure.

In step 302, a plurality of orders may be grouped based on the grouping parameter.

In this embodiment, a process of scheduling, based on the adjusted delivery capacity pressure, a plurality of orders corresponding to the same delivery area and received within the current scheduling period is described by taking order grouping as an example.

First, the grouping parameter needed to group the plurality of orders may be determined. The grouping parameters may include a similarity threshold and an order quantity upper limit.

Specifically, determining the grouping parameter based on the adjusted delivery capacity pressure can follow the following rules.

If the delivery capacity pressure is increased, the similarity threshold can be lowered and the order quantity upper limit can be increased. If the delivery capacity pressure is decreased, the similarity threshold can be increased and the order quantity upper limit can be lowered. If the delivery capacity pressure is not changed, the original similarity threshold and order quantity upper limit may remain unchanged. In practical applications, a correspondence between the delivery capacity pressure, the similarity threshold, and the order quantity upper limit can be set according to the rule, so as to determine the similarity threshold and the order quantity upper limit corresponding to the adjusted delivery capacity pressure based on the correspondence.

After the similarity threshold and the order quantity upper limit corresponding to the adjusted delivery capacity pressure are determined, the plurality of orders can be grouped by comparing a similarity between two orders and a similarity threshold. Meanwhile it needs to be ensured that the order quantity in each order group does not exceed the order quantity upper limit. Similarity measurement parameters between two orders may include, for example, one or more of a distance between source addresses, a distance between destination addresses, and a difference between expected delivery times of two orders. Similarity measurement parameters can have an identical weight or different weights.

The foregoing process of order grouping scheduling is described in detail below with reference to one example. In this example, it is assumed that the plurality of orders include: order 1, order 2, order 3, order 4, order 5, order 6, order 7, and order 8, and it is assumed that before the delivery capacity pressure is adjusted, an original grouping parameter determined based on the delivery capacity pressure before the adjustment includes: a similarity threshold S1, and an order quantity upper limit N1, which is assumed to be 3. Based on the similarity threshold and the order quantity upper limit, it is assumed that the result of order grouping is as follows: order 1, order 2, and order 3 constitute a group 1; order 4, order 5, and order 6 constitute a group 2; and order 7 and order 8 constitute a group 3. In this case, three delivery persons are needed to complete the delivery of the plurality of orders.

In addition, if the adjustment to the delivery capacity pressure increases the delivery capacity pressure, the similarity threshold can be lowered to S2 and the order quantity upper limit can be increased to N2. That is, S2 may be less than S1, and N2 may be greater than N1. For example, N2 may be 4. In this case, the result of order grouping may become: order 1, order 2, order 3, and order 8 constitute a group 1; and order 4, order 5, order 6, and order 7 constitute a group 2. In this case, only two delivery persons are needed to complete the delivery of the plurality of orders. Thus, when the delivery capacity pressure is high, this foregoing method may avoid involving too many delivery persons.

On the contrary, if the adjustment to the delivery capacity pressure decreases the delivery capacity pressure, the similarity threshold can be increased to S3 and the order quantity upper limit is decreased to N3. That is, S3 may be greater than S1, and N3 may be less than N1. For example, N1 may be 2. In this case, the result of order grouping may become: order 1 and order 2 constitute a group 1; order 3 and order 8 constitute a group 2; order 4 and order 5 constitute a group 3; and order 6 and order 7 constitute a group 4. In this case, four delivery persons are needed to complete the delivery of the plurality of orders. Since the delivery capacity pressure is relatively small in this case, more delivery persons can be involved to complete the delivery of the plurality of orders, and the delivery timeliness may be improved.

FIG. 4 is a flowchart illustrating another implementation of step 104 in the embodiment shown in FIG. 1. As shown in FIG. 4, step 104 may include the following steps 401 to 402.

In step 401, an order combination parameter may be determined based on adjusted delivery capacity pressure.

In step 402, a plurality of orders for a delivery person may be combined based on the order combination parameter.

In this embodiment, a process of scheduling, based on the adjusted delivery capacity pressure, a plurality of orders corresponding to the same delivery area and received within a current scheduling period is described by taking order combination for a delivery person as an example.

First, the order combination parameters needed to combine orders for a delivery person may be determined. The order combination parameters may include a quantity of uncompleted orders of the delivery person, a quantity of source addresses, and a quantity of destination addresses corresponding to the uncompleted orders of the delivery person.

In one example, assuming an order is denoted as Xi and a delivery person is denoted as Yj. Simply speaking, the order combination may refer to a process of determining whether the order Xi can be assigned to the delivery person Yj, and be delivered by the delivery person Yj. Different from order grouping, in order combination, the plurality of orders may be combined for a delivery person on an order-by-order basis.

Specifically, the following rules may be used to determine the order combination parameters based on the adjusted delivery capacity pressure.

If the delivery capacity pressure is increased, the order combination difficulty can be reduced (i.e., two orders are allowed to be combined more easily). If the delivery capacity pressure is decreased, the order combination difficulty can be increased (i.e., two orders are more difficult to be combined). If the delivery capacity pressure is not changed, the original order combination parameter may remain unchanged. In practical applications, a correspondence between the delivery capacity pressure and the order combination parameters can be set according to the rule, so that the order combination parameter corresponding to the adjusted delivery capacity pressure may be determined based on the correspondence.

For example, in the case that the order combination parameter is a quantity of uncompleted orders of the delivery person, reducing the order combination difficulty may refer to increasing the quantity of uncompleted orders of the delivery person. That is, the upper limit of the quantity of uncompleted orders of the delivery person can be increased so that orders can also be combined for a delivery person who already has a relatively large quantity of uncompleted orders. On the contrary, increasing the order combination difficulty may refer to lowering the quantity of uncompleted orders of the delivery person. That is, the upper limit of the quantity of uncompleted orders of the delivery person may be lowered so that orders can be more easily combined to a delivery person who has a smaller quantity of uncompleted orders.

After the order combination parameters corresponding to the adjusted delivery capacity pressure are determined, for any one of the foregoing plurality of orders, when the order is subject to order combination for a particular delivery person X, the order can first be pre-assigned to the delivery person X, then whether current uncompleted orders of the delivery person X can meet the limit of the order combination parameter may be further determined. If it does, the order may be eventually assigned to the delivery person X. In the case that the order combination parameter is the foregoing quantity of uncompleted orders of the delivery person, and assuming that the quantity of uncompleted orders is 8, if, after the order is pre-assigned to the delivery person X, the quantity of current uncompleted orders of the delivery person X is less than or equal to 8, the order may be eventually assigned to the delivery person X.

It should be noted that, if the scheduling process of the plurality of orders involves both the grouping process and the order combination process, optionally, the order combination process can be preferentially performed for each of the plurality of orders. Then remaining orders that fail to be combined for a delivery person during order combination may be grouped to obtain one or more order groups. Further, the generated order groups may be respectively assigned to appropriate delivery persons according to an order group assignment rule. The assignment rule can also be regarded as an order combination process.

In the foregoing embodiments, a case where future delivery capacity pressure has an obvious dropping trend is taken as an example to illustrate how to improve the delivery efficiency. In that case, the future delivery capacity pressure has the obvious dropping trend, indicating that average delivery pressure of delivery persons in the future is relatively small. Thus, in order to improve the delivery efficiency for orders, the delivery capacity pressure within the current scheduling period can be decreased, the similarity threshold can be increased, the order quantity upper limit can be reduced, and the order combination difficulty can be increased, so that after the orders are grouped, a larger quantity of order groups may be obtained, and the quantity of orders in an order group may become smaller, so that more delivery persons can be involved to quickly complete the delivery of the order groups to improve the delivery efficiency for orders. Moreover, since the order combination difficulty is increased, the order groups can be assigned to more suitable delivery persons, such as a delivery person who has a less quantity of uncompleted orders. Thus, order quantities of delivery persons are more balanced and the delivery capacity may be more efficiently utilized. Meanwhile, since the corresponding delivery orders are assigned to more suitable delivery persons to complete, the delivery efficiency can be further improved.

Order scheduling apparatuses according to one or more embodiments of this disclosure are described in detail below. These order scheduling apparatuses can be implemented in a basic server infrastructure or in a server architecture during client-server interaction. Persons skilled in the art can understand that these order scheduling apparatuses can all be constructed using commercially available hardware components as taught by this solution.

FIG. 5 is a schematic structural diagram of an order scheduling apparatus in accordance with a first embodiment of this disclosure. As shown in FIG. 5, the apparatus may include: a first determination module 11, an obtaining module 12, an adjustment module 13, and a scheduling module 14.

The first determination module 11 may be configured to determine delivery capacity pressure corresponding to a delivery area within a current scheduling period.

The obtaining module 12 may be configured to predict, based on historical data, a delivery capacity pressure change trend corresponding to the current scheduling period.

The adjustment module 13 may be configured to adjust the delivery capacity pressure based on the delivery capacity pressure change trend.

The scheduling module 14 may be configured to schedule, based on the adjusted delivery capacity pressure, a plurality of orders corresponding to the delivery area within the current scheduling period.

In some embodiments, the adjustment module 13 may be specifically configured to: in response to a determination, based on the delivery capacity pressure change trend, that a change amplitude of a delivery capacity pressure is less than a preset threshold, maintain the delivery capacity pressure unchanged; in response to a determination, based on the delivery capacity pressure change trend, that the delivery capacity pressure rises more than the preset threshold, increase the delivery capacity pressure according to a first preset adjustment coefficient; and in response to a determination, based on the delivery capacity pressure change trend, that the delivery capacity pressure drops more than the preset threshold, decrease the delivery capacity pressure according to a second preset adjustment coefficient.

The apparatus shown in FIG. 5 can implement the method of the embodiment shown in FIG. 1. Related description for the embodiments shown in FIG. 1 may be referred to for the detail implementation process and the technical effect of the apparatus, which are not repeatedly presented herein for the sake of conciseness.

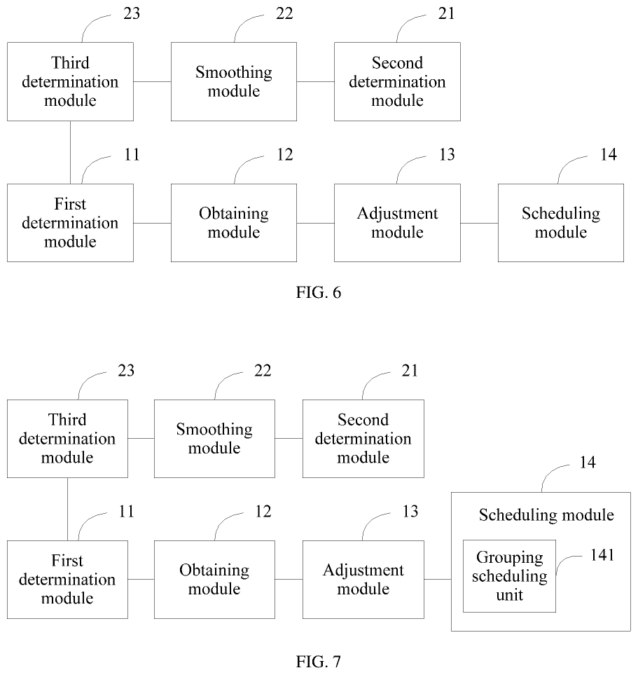

FIG. 6 is a schematic structural diagram of an order scheduling apparatus in accordance with a second embodiment of this disclosure. As shown in FIG. 6, the apparatus may, in additional to the embodiment shown in FIG. 5, further include: a second determination module 21, a smoothing module 22, and a third determination module 23.

The second determination module 21 may be configured to determine respective historical average delivery capacity pressure corresponding to the delivery area within a plurality of scheduling periods, and the historical average delivery capacity pressure may correspond to an average value of delivery capacity pressure in a plurality of days.

The smoothing module 22 may be configured to smooth the historical average delivery capacity pressure corresponding to the plurality of scheduling periods.

The third determination module 23 may be configured to determine a delivery capacity pressure change trend corresponding to an i^{th} scheduling period (i.e., a selected scheduling period) in the plurality of scheduling periods based on historical average delivery capacity pressure corresponding to at least one scheduling period following the i^{th} scheduling period.

The apparatus shown in FIG. 6 can implement the method of the embodiment shown in FIG. 2. Related description for the embodiments shown in FIG. 2 may be referred to for the detail implementation process and the technical effect of the apparatus, which are not repeatedly described herein for the sake of conciseness.

FIG. 7 is a schematic structural diagram of an order scheduling apparatus in accordance with a third embodiment of this disclosure. As shown in FIG. 7, in addition to the embodiment shown in FIG. 5, in the apparatus of FIG. 7, the scheduling module 14 may further include: a grouping scheduling unit 141 configured to determine a grouping parameter based on the adjusted delivery capacity pressure, and to group the plurality of orders based on the grouping parameter.

The apparatus shown in FIG. 7 can implement the method of the embodiment shown in FIG. 3. Related description for the embodiments shown in FIG. 3 may be referred to for the detail implementation process and the technical effect of the apparatus, which are not repeatedly described herein for the sake of conciseness.

FIG. 8 is a schematic structural diagram of an order scheduling apparatus in accordance with a fourth embodiment of this disclosure. As shown in FIG. 8, in addition to the embodiment shown in FIG. 5 or FIG. 7 (taking the embodiment shown in FIG. 7 as an example), in the apparatus of FIG. 8, the scheduling module 14 may further include an order combination scheduling unit 142.

The order combination scheduling unit 142 may be configured to determine an order combination parameter based on the adjusted delivery capacity pressure, and to combine the plurality of orders for a delivery person based on the order combination parameter.

The apparatus shown in FIG. 8 can implement the method of the embodiment shown in FIG. 4. Related description for the embodiments shown in FIG. 4 may be referred to for the detail implementation process and the technical effect of the apparatus, which are not repeatedly presented herein for the sake of conciseness.

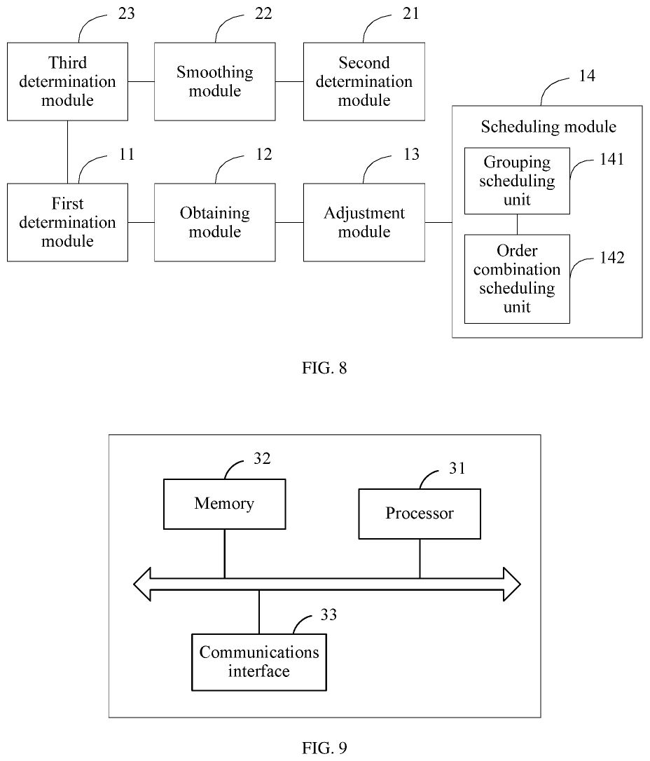

The internal functions and structures of the order scheduling apparatus are described above. In some embodiments, the structure of the order scheduling apparatus can be implemented as an electronic device. The electronic device, such as a server, may include: a processor 31 and a memory 32, as shown in FIG. 9. The memory 32 may be configured to store a program executable by the processor 31. Upon being executed by the processor 31, the program may cause the processor 31 to perform the order scheduling method provided in any of the foregoing embodiments.

The program may include one or more computer instructions. The one or more computer instructions may be executed by the processor 31.

The processor 31 may be configured to: determine delivery capacity pressure corresponding to a delivery area within a current scheduling period; obtain a delivery capacity pressure change trend corresponding to the current scheduling period; adjust the delivery capacity pressure based on the delivery capacity pressure change trend; and schedule, based on the adjusted delivery capacity pressure, a plurality of orders corresponding to the delivery area within the current scheduling period.

The processor 31 may be further configured to execute all or some of the steps in the foregoing method embodiments.

The order scheduling apparatus may also include a communication interface 33 for the order scheduling apparatus to communicate with other devices or communications networks.

This disclosure further provides a computer storage medium configured to store computer software instructions for an order scheduling apparatus. The computer software instructions may include a program related to executing the order scheduling method according to any of the foregoing method embodiments.

The apparatus embodiments described above are merely examples. Units described as separate components may be or may not be physically separated, and components displayed as units may be or may not be physical units. That is, they may be located at the same place, or they may be distributed to a plurality of network units. Some or all modules may be selected according to actual needs to achieve the purpose of the solution of the embodiments. Persons skilled in the art could achieve understanding and implementation without involving any inventive effort.

Through the description of the foregoing implementations, a person skilled in the art may clearly understand that all the embodiments may be implemented by using software in combination with a necessary universal hardware platform, or by using hardware. Based on such an understanding, the foregoing technical solutions (or the part thereof advantageous to existing technologies) may be implemented in a form of a product. The computer product can be stored in a computer-readable storage medium such as a ROM/RAM, a disk, or an optical disk, and includes several instructions for causing a computer apparatus (which may be a personal computer, a server, a network apparatus, or the like) to execute the methods described in various embodiments or in some parts of the embodiments.

Finally, it should be noted that the foregoing embodiments are merely intended for describing but not limiting the technical solutions of this disclosure. Although this disclosure is described in detail with reference to the foregoing embodiments, a person of ordinary skill in the art should understand that they may still make modifications to the technical solutions described in the foregoing embodiments or make equivalent replacements to some technical features thereof, and such modifications and replacements do not cause the essence of the corresponding technical solutions to depart from the spirit or scope of the technical solutions of the embodiments of this disclosure.

What is claimed is:

1. An order scheduling method, comprising:
determining delivery capacity pressure corresponding to a delivery area within a current scheduling period, wherein the delivery capacity pressure is a ratio of a quantity of uncompleted orders to a quantity of delivery persons corresponding to the delivery area within the current scheduling period;
predicting, based on historical data, a delivery capacity pressure change trend corresponding to the current scheduling period;
adjusting, based on the delivery capacity pressure change trend, the delivery capacity pressure; and
scheduling, based on a grouping parameter and/or an order combination parameter determined by the adjusted delivery capacity pressure, a plurality of orders corresponding to the delivery area within the current scheduling period.

2. The method of claim 1, wherein adjusting, based on the delivery capacity pressure change trend, the delivery capacity pressure comprises:
in response to a determination, based on the delivery capacity pressure change trend, that a change amplitude of a delivery capacity pressure is less than a preset threshold, maintaining the delivery capacity pressure unchanged;
in response to a determination, based on the delivery capacity pressure change trend, that the delivery capacity pressure rises more than the preset threshold, increasing the delivery capacity pressure according to a first preset adjustment coefficient; and
in response to a determination, based on the delivery capacity pressure change trend, that the delivery capacity pressure drops more than the preset threshold, decreasing the delivery capacity pressure according to a second preset adjustment coefficient.

3. The method of claim 2, wherein scheduling, based on the adjusted delivery capacity pressure, a plurality of orders corresponding to the delivery area within the current scheduling period comprises at least one of the following two operations:
(1): determining, based on the adjusted delivery capacity pressure, the grouping parameter; and
grouping, based on the grouping parameter, the plurality of orders, and
(2): determining, based on the adjusted delivery capacity pressure, the order combination parameter; and
combining, based on the order combination parameter, the plurality of orders for a delivery person.

4. The method of claim 3, wherein the determining delivery capacity pressure corresponding to a delivery area within a current scheduling period comprises:
obtaining the quantity of uncompleted orders and the quantity of delivery persons corresponding to the delivery area within the current scheduling period; and
determining, based on the quantity of uncompleted orders and the quantity of delivery persons, the delivery capacity pressure.

5. The method of claim 2, wherein the determining delivery capacity pressure corresponding to a delivery area within a current scheduling period comprises:
obtaining the quantity of uncompleted orders and the quantity of delivery persons corresponding to the delivery area within the current scheduling period; and
determining, based on the quantity of uncompleted orders and the quantity of delivery persons, the delivery capacity pressure.

6. The method of claim 1, wherein the determining delivery capacity pressure corresponding to a delivery area within a current scheduling period comprises:
obtaining the quantity of uncompleted orders and the quantity of delivery persons corresponding to the delivery area within the current scheduling period; and
determining, based on the quantity of uncompleted orders and the quantity of delivery persons, the delivery capacity pressure.

7. The method of claim 1, further comprising:
determining historical average delivery capacity pressure corresponding to the delivery area within each of a plurality of scheduling periods, the historical average delivery capacity pressure corresponding to an average value of delivery capacity pressure in a plurality of days; and
determining, based on historical average delivery capacity pressure corresponding to at least one scheduling period following a selected scheduling period from the plurality of scheduling periods, a delivery capacity pressure change trend corresponding to the selected scheduling period.

8. The method of claim 7, further comprising: after determining historical average delivery capacity pressure corresponding to the delivery area within each of a plurality of scheduling periods,
smoothing the historical average delivery capacity pressure corresponding to each of the plurality of scheduling periods.

9. An order scheduling apparatus, comprising:
a first determination module, configured to determine delivery capacity pressure corresponding to a delivery area within a current scheduling period, wherein the delivery capacity pressure is a ratio of a quantity of uncompleted orders to a quantity of delivery persons corresponding to the delivery area within the current scheduling period;
an obtaining module, configured to predict, based on historical data, a delivery capacity pressure change trend corresponding to the current scheduling period;
an adjustment module, configured to adjust, based on the delivery capacity pressure change trend, the delivery capacity pressure; and
a scheduling module, configured to schedule, based on a grouping parameter and/or an order combination parameter determined by the adjusted delivery capacity pressure, a plurality of orders corresponding to the delivery area within the current scheduling period.

10. The apparatus of claim 9, wherein the adjustment module is further configured to:
in response to a determination, based on the delivery capacity pressure change trend, that a change amplitude of a delivery capacity pressure is less than a preset threshold, maintain the delivery capacity pressure unchanged;
in response to a determination, based on the delivery capacity pressure change trend, that the delivery capacity pressure rises more than the preset threshold, increase the delivery capacity pressure according to a first preset adjustment coefficient; and
in response to a determination, based on the delivery capacity pressure change trend, that the delivery capacity pressure drops more than the preset threshold, decrease the delivery capacity pressure according to a second preset adjustment coefficient.

11. The apparatus of claim 10, wherein the scheduling module comprises at least one of a grouping scheduling unit and an order combination scheduling unit, wherein the grouping scheduling unit is configured to:
determine, based on the adjusted delivery capacity pressure, the grouping parameter; and
group, based on the grouping parameter, the plurality of orders,
and wherein the order combination scheduling unit is configured to:
determine, based on the adjusted delivery capacity pressure, the order combination parameter; and
combine, based on the order combination parameter, the plurality of orders for a delivery person.

12. The apparatus of claim 11, further comprising:
a second determination module, configured to determine historical average delivery capacity pressure corresponding to the delivery area within each of a plurality scheduling periods, the historical average delivery capacity pressure corresponding to an average value of delivery capacity pressure in a plurality of days; and
a third determination module, configured to determine, based on historical average delivery capacity pressure corresponding to at least one scheduling period after a selected scheduling period from the plurality of scheduling periods, a delivery capacity pressure change trend corresponding to the selected scheduling period.

13. The apparatus of claim 12, further comprising:
a smoothing module, configured to smooth the historical average delivery capacity pressure corresponding to each of the plurality of scheduling periods.

14. The apparatus of claim 10, further comprising:
a second determination module, configured to determine historical average delivery capacity pressure corresponding to the delivery area within each of a plurality scheduling periods, the historical average delivery capacity pressure corresponding to an average value of delivery capacity pressure in a plurality of days; and
a third determination module, configured to determine, based on historical average delivery capacity pressure corresponding to at least one scheduling period after a selected scheduling period from the plurality of scheduling periods, a delivery capacity pressure change trend corresponding to the selected scheduling period.

15. The apparatus of claim 14, further comprising:
a smoothing module, configured to smooth the historical average delivery capacity pressure corresponding to each of the plurality of scheduling periods.

16. The apparatus of claim 9, further comprising:
a second determination module, configured to determine historical average delivery capacity pressure corresponding to the delivery area within each of a plurality scheduling periods, the historical average delivery capacity pressure corresponding to an average value of delivery capacity pressure in a plurality of days; and
a third determination module, configured to determine, based on historical average delivery capacity pressure corresponding to at least one scheduling period after a selected scheduling period from the plurality of scheduling periods, a delivery capacity pressure change trend corresponding to the selected scheduling period.

17. The apparatus of claim 16, further comprising:
a smoothing module, configured to smooth the historical average delivery capacity pressure corresponding to each of the plurality of scheduling periods.

18. An electronic device, comprising: a processor and a memory,
wherein the memory is configured to store one or more computer instructions executable by the processor, and wherein upon being executed by the processor, the one or more computer instructions cause the processor to perform an order scheduling method comprising:
determining delivery capacity pressure corresponding to a delivery area within a current scheduling period, wherein the delivery capacity pressure is a ratio of a quantity of uncompleted orders to a quantity of delivery persons corresponding to the delivery area within the current scheduling period;
predicting, based on historical data, a delivery capacity pressure change trend corresponding to the current scheduling period;
adjusting, based on the delivery capacity pressure change trend, the delivery capacity pressure; and
scheduling, based on a grouping parameter and/or an order combination parameter determined by the adjusted delivery capacity pressure, a plurality of orders corresponding to the delivery area within the current scheduling period.

19. A computer-readable storage medium, storing a computer instruction executable by a processor, wherein upon being executed by the processor, the computer instruction causes the processor to perform an order scheduling method, comprising:
determining delivery capacity pressure corresponding to a delivery area within a current scheduling period, wherein the delivery capacity pressure is a ratio of a quantity of uncompleted orders to a quantity of delivery persons corresponding to the delivery area within the current scheduling period;
predicting, based on historical data, a delivery capacity pressure change trend corresponding to the current scheduling period;
adjusting, based on the delivery capacity pressure change trend, the delivery capacity pressure; and
scheduling, based on a grouping parameter and/or an order combination parameter determined by the adjusted delivery capacity pressure, a plurality of orders corresponding to the delivery area within the current scheduling period.
